(19) United States
(12) Patent Application Publication
(10) Pub. No.: US 2011/0314965 A1
(43) Pub. Date: Dec. 29, 2011

(54) METAL POWDER FOR POWDER METALLURGY AND SINTERED BODY

(75) Inventor: Hidefumi NAKAMURA, Hachinohe (JP)

(73) Assignee: SEIKO EPSON CORPORATION, Tokyo (JP)

(21) Appl. No.: 13/114,370

(22) Filed: May 24, 2011

(30) Foreign Application Priority Data
Jun. 24, 2010 (JP) 2010-143441

(51) Int. Cl. B32B 15/02; C22C 38/50; B22F 1/00; C22C 38/28; C22C 38/08; C22C 38/44; C22C 38/22

(52) U.S. Cl. 75/243; 420/53; 420/110; 420/109; 420/119; 420/99; 420/68; 75/246

(57) ABSTRACT

There is provided a metal powder for powder metallurgy including Zr and Si in a manner such that following conditions of (A) and (B) are satisfied, wherein a remainder thereof includes at least one element selected from the group consisting of Fe, Co and Ni, (A) the mass ratio of a content of Zr to a content of Si is 0.03 to 0.3, and (B) the content of Si is 0.35 to 1.5% by mass.

### BACKGROUND

1. Technical Field

The present invention relates to a metal powder for powder metallurgy and a sintered compact.

2. Related Art

In a powder metallurgy method, after a composition including a metal powder and a binder is molded to have a desired shape and thereby a green part is obtained, the green part is debinded and sintered, and thereby a sintered compact is produced. In a producing process of such a sintered compact, an atomic diffusion phenomenon occurs between particles of the metal powder, and thereby the green part is gradually densified and is sintered.

For example, in JP-A-6-10088, there is disclosed a method of sintering a stainless steel powder where a mixture, which is obtained by mixing and kneading the stainless steel powder and a thermoplastic binder, is injection-molded to obtain a green part, and the green part is debinded and sintered to obtain a sintered compact.

However, there is a case where the rate of the atomic diffusion between particles may be slow depending on a composition of the metal powder. In this case, there is a concern that a sintering property will be significantly decreased, and thereby the densification of the sintered compact will not progress sufficiently.

Specifically, for example, in a case where the metal powder used is a powder with a composition by which an atomic arrangement becomes a face-centered cubic lattice at a sintering temperature, each atom is arranged into a dense face-centered cubic lattice structure at the sintering temperature, and thereby the progress of the sintering is obstructed and the densification is difficult to progress. Therefore, in regard to such a metal powder, even when a sintered compact is obtained by a method disclosed in JP-A-6-10088, in the obtained sintered compact, the densification becomes insufficient and thereby mechanical properties deteriorate.

In addition, regardless of the composition of the metal powder, the densification of a sintered compact is difficult to progress in a low temperature sintering range, and it is difficult to improve mechanical properties of the obtained sintered compact. On the contrary, when the sintering temperature is raised to improve mechanical properties, a temperature variation easily occurs, such that the progress of densification may be nonuniform, and thereby it is difficult to expect a sufficient improvement in mechanical properties. Therefore, dimensional accuracy of the sintered compact is decreased, and the time and cost necessary for the sintering are considerably increased.

### SUMMARY

An advantage of some aspects of the invention is to provide a metal powder for powder metallurgy that can be used to easily produce a sintered compact that has a high density and is excellent in terms of mechanical properties, even in a case of a composition with an inferior sintering property or in a case where sintering is performed in a low temperature range, and a dense sintered compact produced by using the metal powder for powder metallurgy.

An aspect of the invention is directed to a metal powder for powder metallurgy including Zr and Si in a manner such that following conditions of (A) and (B) are satisfied, wherein a remainder thereof includes at least one element selected from a group consisting of Fe, Co and Ni, and inevitable element.
(A) when the mass ratio of a content of Zr to a content of Si is 0.03 to 0.3.
(B) the content of Si is 0.35 to 1.5% by mass.

According to this configuration, even in a case of a composition with an inferior sintering property or in a case where sintering is performed in a low temperature range, it is possible to obtain a metal powder for powder metallurgy that can be used to easily produce a sintered compact that has a high density and is excellent in terms of mechanical properties.

In the metal powder for powder metallurgy according to the aspect of the invention, it is preferable that the content of Zr is 0.015 to 0.3% by mass.

According to this configuration, an absolute amount of Zr is optimized, such that a synergistic operation of Zr and Si is obtained, as well as an operation by Zr as a single element being obtained.

In the metal powder for powder metallurgy according to the aspect of the invention, it is preferable that C (carbon) is further included, and the mass ratio of a content of C to the content of Si is 0.001 to 3.

According to this configuration, the densification of the metallic material progresses. In addition, when the content of C is set within the range, a relative amount of C with respect to Zr and Si is optimized, and thereby it is possible to reliably obtain the synergistic effect by Zr and Si.

In the metal powder for powder metallurgy according to the aspect of the invention, it is preferable that the content of C is 0.001 to 2.5% by mass.

According to this configuration, an absolute amount of C is optimized, and a synergistic effect by C, Zr and Si can be reliably exhibited.

In the metal powder for powder metallurgy according to the aspect of the invention, it is preferable that the metallic material is a Fe-based alloy, the content of Zr is 0.03 to 0.1% by mass, the content of Si is 0.5 to 0.8% by mass, and the content of C is 0.1 to 0.7% by mass.

According to this configuration, an amount of each of Zr, Si and C is optimized, such that the most excellent synergistic effect is obtained, and it is possible to obtain a metal powder for powder metallurgy that can be used to produce a particularly dense sintered compact.

In the metal powder for powder metallurgy according to the aspect of the invention, it is preferable that the metallic material is an austenitic stainless steel.

According to this configuration, it is possible to obtain a metal powder for powder metallurgy that can be used to produce a stainless steel sintered compact that is particularly excellent in terms of mechanical properties and chemical properties.

In the metal powder for powder metallurgy according to the aspect of the invention, it is preferable that a composition of the metallic material is a composition where an atomic arrangement at a sintering temperature is a face-centered cubic lattice.

According to this configuration, the filling rate of atoms becomes high, such that a metal powder for powder metallurgy that can be used to produce a sintered compact that is excellent in terms of mechanical properties and chemical properties may be obtained.

In the metal powder for powder metallurgy according to the aspect of the invention, it is preferable that the metallic material, and the Zr and Si form an alloy or an intermetallic compound.

According to this configuration, the metallic material and additive (Zr and Si) are uniformly distributed in each particle of the metal powder. As a result thereof, the operation of the additive is uniformly exhibited over the entirety of the metal powder, and eventually, it is possible to prevent sintering variation from occurring.

In the metal powder for powder metallurgy according to the aspect of the invention, it is preferable that a mean particle size is 1 to 30

According to this configuration, it is possible to obtain a metal powder for powder metallurgy that can be used to eventually produce a sintered compact that is sufficiently dense while avoiding a decrease in a compaction property at the time of the molding.

In the metal powder for powder metallurgy according to the aspect of the invention, it is preferable that the metal powder for powder metallurgy is produced by an atomizing method.

According to this configuration, it is possible to obtain a metal powder for powder metallurgy with a uniform particle size. In addition, a particle having a spherical shape, which is relatively close to a perfect sphere, is obtained, such that the metal powder becomes excellent in dispersibility and flowability with respect to a binder. Therefore, when a composition including such a metal powder is filled in a mold, it is possible to increase the filling property, and eventually, it is possible to obtain a denser sintered compact.

Another aspect of the invention is directed to a sintered compact that is produced by molding the metal powder for powder metallurgy into a predetermined shape, and sintering the obtained green part.

According to this configuration, even in a case of a composition with an inferior sintering property or in a case where sintering is performed in a low temperature range, it is possible to obtain a sintered compact that has a high density and is excellent in terms of mechanical properties.

In the sintered compact according to the aspect of the invention, it is preferable that a relative density is 96% or more.

According to the aspect of the invention, even when the sintered compact has a shape nearly close to an intended shape, it is possible to obtain a sintered compact that has excellent mechanical properties comparable to a cast material and can be adapted to various mechanical parts or the like without being post-processed.

### BRIEF DESCRIPTION OF THE DRAWINGS

The invention will be described with reference to the accompanying drawings, wherein like numbers reference like elements.

The FIGURE is a graph illustrating a relative density of sintered bodies, which are obtained in an example 3D and each of comparative examples 2D to 7D, for each sintering temperature.

### DESCRIPTION OF EXEMPLARY EMBODIMENTS

Hereinafter, a metal powder for powder metallurgy and a sintered body according to the invention will be described in detail with reference to accompanying drawings.

### Metal Powder for Powder Metallurgy

First, the metal powder for powder metallurgy according to the invention will be described.

In powder metallurgy, a composition including a metal powder for powder metallurgy and a binder is molded into a desired shape, and is dibinded and sintered, and thereby it is possible to obtain a sintered body with a desired shape. According to such a powder metallurgy technology, there is an advantage in that it is possible to produce a sintered compact having a complex and fine shape with a near net (close to an eventual shape) compared to other metallurgy technology.

As the metal powder for powder metallurgy used in the powder metallurgy, it is possible to use a metal powder with various compositions in the related art. However, since a sintering property may be decreased depending on a composition of a metal powder used, there is a problem in that the densification of sintered compact may be insufficient. Such a problem becomes remarkable in a case where as a metal powder for powder metallurgy, a powder having a composition where an atomic arrangement becomes a face-centered cubic lattice at a sintering temperature is used, or an iron group element such as Fe, Co and Ni is used.

In addition, a density of a sintered compact is increased by raising a sintering temperature, but in this case, a temperature variation in the sintered compact is apt to occur, and thereby the progress of the densification is apt to be nonuniform. As a result thereof, the density of the sintered compact becomes nonuniform, and thereby it is difficult to sufficiently improve mechanical properties.

In consideration of the above-described problems, the inventors have extensively studied to find a condition that exhibits an excellent sintering property and is capable of obtaining a fine sintered compact, even in a case of a composition with a low sintering property or in a case where sintering is performed in a low temperature range. As a result thereof, the present inventors have completed a metal powder for powder metallurgy according to the invention.

Hereinafter, the metal powder for powder metallurgy according to the invention will be described in detail.

A metallic material, which is a main component of the metal powder for powder metallurgy according to the invention, is a metallic material including at least one kind selected from a group consisting of Fe, Co and Ni. A sintered body, which is obtained from such a metallic material, is excellent in terms of mechanical properties and electromagnetic properties, such that the sintered compact can be appropriately used in a wide range of fields as various structural parts, electromagnetic parts, or the like. Therefore, the metal powder for powder metallurgy, which includes this metallic material as a main component, is suitable as a raw powder for producing structural parts or electromagnetic parts that are dense and are excellent in terms of mechanical properties or electromagnetic properties.

As such a metallic material, for example, a ferritic, austenitic or martensitic stainless steel, a chromium-molybdenum steel, a nickel-chromium-molybdenum steel, a high-alloy steel, a low-alloy steel, a steel for machine structure use, a high toughness steel, a tool steel, a high hardness steel, a heat-resistant steel, a low-carbon steel, a superalloy, an Fe-based alloy such as a Permalloy, an Ni-based alloy such as an Inconel, a Co-based alloy such as a Co—Cr series alloy and a Co—Cr—Mo series alloy may be exemplified.

In addition, the stainless steel and heat-resistant steel are steel types mainly including a component such as Fe, Ni, and Cr.

Among these, as the austenitic stainless steel, for example, stainless steels defined in JIS G 4303 to 4309, or the like, SUS 301, SUS 302, SUS 303, SUS 304, SUS 305, SUS 309, SUS 310, SUS 316, SUS 317, SUS 321, SUS 347, SUS 384, or the like may be exemplified.

In addition, as the austenitic heat-resistant steel, heat-resistant steels defined in JIS G 4311 to 4312, or the like, for example, SUH 31, SUH 35, SUH 36, SUH 37, SUH 38, SUH 309, SUH 310, SUH 330, SUH 660, SUH 661, or the like may be exemplified.

On the other hand, as the ferritic stainless steel, for example, SUS 405, SUS 410L, SUS 429, SUS 430, SUS 434, SUS 436L, SUS 444, SUS 447J1, or the like may be exemplified.

Furthermore, as the martensitic stainless steel, for example, SUS 403, SUS 410, SUS 416, SUS 420, SUS 431, SUS 440, or the like may be exemplified.

A highly dense sintered body of such stainless steel and heat-resistant steel can exhibit an excellent performance as a structural part or the like.

In addition, as the chromium-molybdenum steel, for example, SCM430, SCM415, SCM420, or the like may be exemplified.

In addition, as the nickel-chromium-molybdenum steel, for example, alloy steels for machine structure use defined in JIS G 4053 or the like may be exemplified.

In addition, as the low-alloy steel, for example, Fe2Ni, Fe2NiC, Fe8Ni, Fe8NiC, or the like may be exemplified.

In addition, generally, the low-carbon steel indicates a carbon steel in which a content of carbon is substantially 0.02 to 0.3 mass %.

In addition, as Permalloy, for example, an iron-nickel soft magnetic material or the like, which is defined in JIS C 2531 or the like, may be exemplified, and as Inconel, for example, a corrosion and heat resistant superalloy or the like, which is defined in JIS G 4901, 4902, may be exemplified.

In addition, the Co—Cr—Mo series alloy is appropriately used for a device for medical use (implant) such as an artificial joint.

The Co—Cr—Mo series alloy is a Co-based alloy including Cr and Mo, but specifically, it is preferable that a content of Cr is substantially 26 to 30 mass %, and more preferably, substantially 27 to 29 mass %. In addition, it is preferable that a content of Mo is substantially 4.5 to 7 mass o, and more preferably 5 to 6.5 mass %. The Co—Cr—Mo series alloy with such a composition is excellent in terms of mechanical strength, such that it is particularly suitable as a constituent material of the above-described device for medical use.

Among these, as the metallic material, a metallic material having a composition where an atomic arrangement becomes a face-centered cubic lattice in a sintering temperature is preferably used. As such a composition, for example, an austenitic Fe-based alloy such as an austenitic stainless steel and an austenitic heat-resistant steel may be exemplified. These are materials having various excellent properties, since a filling rate of atoms (positive ions) in face-centered cubic lattice is relatively high. That is, when these materials are used, it is possible to obtain a sintered compact that is excellent in terms of mechanical properties such as a tensile strength, a hardness and toughness, and chemical properties such as a corrosion resistance.

In addition, inevitable elements may be included in the metal powder for powder metallurgy according to the invention. The “inevitable elements” means elements that remain in each component making up the metal powder for powder metallurgy, even though the component is purified at the time of extracting and producing the component, and that is unavoidably included in the metal powder. As such an inevitable element, for example, various elements such as Be, B, N, O, Si, P, S, Ti, Mn, and W may be exemplified, but it is preferably that the content thereof is 1 mass % or less in the metal powder for powder metallurgy.

In addition, in the contents of the metallic material and the inevitable elements in the metal powder for powder metallurgy, although they are a remainder of an additive described later, it is preferable that the content of the metallic material is 95 mass % or more, and more preferably, mass % or more. When the content is within the above-described range, in the metal powder for powder metallurgy, a property of the metallic material can be sufficiently dominant.

On the other hand, the additive (Zr and Si) is contained in metal powder for powder metallurgy with a content smaller than that of the metallic material that is a main component. Therefore, in the property of metal powder for powder metallurgy, the property of the metallic material becomes dominant, and the content of the above-described additive is set to a degree not deteriorating the property of the main component.

When the content of such an additive is set to the content defined in the above-described conditions of (A) and (B), the additive operates to sufficiently increase the sintering property of the metal powder for powder metallurgy without deteriorating the property of the main component.

Here, an operation of Zr, which is an additive, will be described.

(I) Zr is solid-soluted between metallic materials and forms a low melting point phase, but this low melting point phase causes a rapid atomic diffusion in a sintering process. Therefore, this atomic diffusion acts as a driving force, and thereby an interparticle distance of the metal powder is quickly shortened and a neck is formed between the particles. As a result thereof, densification of a green part progresses, and the green part is quickly sintered.

In addition, each atomic radius of so-called iron group elements such as Fe, Co and Ni that are main elements of the metallic material is significantly close to the others, but is slightly smaller than that of Zr. Specifically, the atomic radii of the iron group elements are close to each other at substantially 0.115 to 0.117 nm, but the atomic radius of Zr is substantially 0.145 nm.

Here, in a binary solid solution, when the atomic radius of the iron group element is set to α, the atomic radius of Zr is set to β, if |α−β|/α exceeds 15%, generally, a main component and an auxiliary component are hard to get solid-solute (Hume-Rothery's law).

On the other hand, in the case of the invention, a value of |α−β|/α is substantially 24%, such that it is considered that the iron group element and Zr are hard to get solid-solute. Therefore, it is considered that Zr is apt to precipitate on the surface of each metal particle, and the above-described low melting point phase is formed on the surface of the metal particle. This low melting point phase serves as a driving force to shorten the interparticle distance without having an effect on the inside of the metal particle. Therefore, it is considered that even when Zr is added, it is possible to obtain a dense sintered body maintaining the property of the main component, without the property of the main component being deteriorated. In addition, when the value of |α−β|/α in Zr exceeds 15% without being significantly different from this value (less than 30%), it is considered that Zr is precipitated with a gradual concentration gradient from an inner side to a surface of the particle. Therefore, the iron group element and Zr get solid-solute to a small extent, such that it is considered that particles are securely bonded and thereby the mechanical properties of the eventually obtained sintered compact are improved.

In addition, even in a case where the metallic material is an alloy including the iron group element, the above-described mechanism is difficult to be changed and a sintering property is improved.

(II) In addition, Zr is a ferrite generating element, such that when metal powder for powder metallurgy is sintered, due to the metallic material including Fe, Co and Ni, and Zr, a phase where atoms are arranged in a manner such that a body-centered cubic lattice is constructed (hereinafter, referred to as “body-centered cubic lattice phase”) is precipitated. This body-centered cubic lattice phase is excellent in a sintering property compared to other crystal lattice phase, for example, a face-centered cubic lattice phase, a close-packed hexagonal lattice, or the like. This is considered to be due to a difference in a flexibility accompanying a difference in a filling property of an atomic arrangement between the body-centered cubic lattice phase and other crystal lattice phase. From this reason, when Zr is added, the sintering property of the metal powder for powder metallurgy is improved.

(III) In addition, when the metal powder for powder metallurgy is sintered, Zr acts as a deoxidizing agent that removes oxygen included in a minute amount as an oxide of the metallic material. Here, the oxide of the metallic material obstructs the sintering of the metal powder for powder metallurgy, and contributes to a decrease in the sintering property, but Zr acts as a deoxidizing agent, such that it is possible to remove the oxide that is an obstructive factor of the sintering. Therefore, the sintering property of the metal powder for powder metallurgy is improved.

As described above, due to an operation of at least one of (I) to (III), it is considered that the sintering property of the metal powder for powder metallurgy is improved.

Hereinafter, an operation of Si that is an additive will be described.

Si is a ferrite generating element, and also serves as a deoxidizing agent. Therefore, similarly to Zr, Si precipitates body-centered cubic lattice phase and removes an oxide that is an obstructive factor of the sintering, and thereby improves the sintering property of the metal powder for powder metallurgy.

Therefore, it has been found that this element does not have sufficient effect by itself. Specifically, in a case where the metallic material is a material that causes a face-centered cubic lattice phase to be precipitated at a sintering temperature, the tendency becomes remarkable. In addition, in a case where a metallic material which includes an iron group element at a large amount is sintered, a sintering at a high temperature is necessary, from viewpoints of an increase in dimensional accuracy and a reduction in costs in regard to heating, it is required to decrease a sintering temperature.

In regard to these problems, the inventions exhibited a finding in that according to a metal powder for powder metallurgy, wherein an additive including Zr and Si is added in a manner such that the following conditions (A) and (B) are satisfied, and a remainder is the metallic material and the inevitable elements, a sintering property thereof is dramatically increased.

(A) when in the metal powder for powder metallurgy, a content of Zr is set to a [mass %] and a content of Si is set to b [mass %], a/b is 0.03 to 0.3.

(B) b is 0.35 to 1.5 mass %.

According to such a metal powder for powder metallurgy, Zr and Si synergistically operate to increase the sintering property of the metallic material. Therefore, in a sintered compact obtained by molding a composition of the metal powder for powder metallurgy according to the invention and a binder, and degreasing and sintering the resultant green part, densification progresses sufficiently. The obtained sintered compact becomes excellent in a relative density, mechanical properties, chemical properties, or the like.

In addition, a reason why Zr and Si have the above-described synergistic effect is not apparent, but a fact that ionic radii of Zr and Si are appropriately different is considered as one reason. When each radius of a Zr⁴⁺ ion and a Si⁴⁺ ion that are considered to be dominant is compared to each other, there is a difference of substantially two times. Therefore, in a case where ions, which are different substantially by two times in a radius thereof, co-exist in the metal powder for powder metallurgy, when ions enter gaps of a crystal lattice of the metallic material that is a main component, a strain of a crystal lattice is compensated for by the pairing of the Zr ion and Si ion, such that it is possible to maintain a structure of the crystal lattice even when relatively more Zr ions and Si ions are included. In other words, in a case where the Zr ion or the Si ion is added by itself, respectively, a strain is accumulated in the crystal lattice based on a radius difference between an ion making up a crystal lattice and an ion of an additive, a sintering property is decreased, and mechanical properties of the sintered compact are also decreased.

On the contrary, according to the invention, Zr and Si are combined and added in a predetermined ratio, such that the strain does not occur in the crystal lattice, and a relatively greater amount of additive can be added. Therefore, Zr and Si operate in all areas of the metallic material, and a particularly significant increase in a sintering property occurs with respect to metallic material. That is, even in a case of a crystal lattice phase such as a face-centered cubic lattice phase having a high filling property, it is considered that a high sintering property may be obtained.

Based on such a reason, when both of these are included in a predetermined ratio, a temperature where a sintering occurs is particularly lowered, and thereby even when heating is performed at a low temperature, it is possible to make a sintered density sufficiently high.

Here, when a/b is less than the above-described lower limit, a relative amount of Zr with respect to Si is significantly decreased, the balance between Zr and Si is destroyed, and a synergistic operation is also lost. On the other hand, when a/b exceeds the upper limit, at this time, a relative amount of Zr with respect to Si is significantly increased, and a balance between Zr and Si is destroyed.

In addition, when b is less than the lower limit, an amount of Si in the metal powder for powder metallurgy is absolutely diminished, and thereby the synergistic operation of Zr and Si is lost. On the other hand, when b exceeds the upper limit, the amount of Si is absolutely increased, and thereby, particularly, the mechanical properties such as toughness or the like of the sintered compact deteriorate.

In addition, in regard to the condition (A), it is preferable that a/b is substantially 0.05 to 0.25, and more preferably, substantially 0.1 to 0.2.

On the other hand, in regard to the condition (B), it is preferable that b is substantially 0.5 to 0.8.

In addition, it is preferable that a is 0.015 to 0.3 mass o, and more preferably, 0.03 to 0.1 mass %. When a is less than the lower limit, the amount of Zr in the metal powder for powder metallurgy is absolutely diminished, and the synergistic operation of Zr and Si and an operation by Zr as a single element are lost. On the other hand, when a exceeds the upper limit, there is a concern that surplus Zr occurs and this may obstruct a fine sintering.

In addition, in the metal powder for powder metallurgy according to the invention, as the additive, it is preferable to include C (carbon) other than Zr and Si. C is an austenite generating element, and an ionic radius thereof is significantly small. Therefore, C significantly easily enters the gaps of the crystal lattice of the metallic material, and thereby C further relaxes the strain of the crystal lattice, and contributes to the densification after the sintering is finished. Furthermore, in a case where a metal oxide remains on a surface of metal powder, the metal oxide is reduced by C, the metal oxide that is an obstructive factor of the sintering is removed, and thereby the densification of the metallic material progresses.

Specifically, C causes the synergistic effect together with Zr and Si, and can further increase the sintering property of the metal powder for powder metallurgy. In addition, since the C ion (C⁴⁺), which is considered to be dominant, has a radius substantially half that of the radius of Si, the C ion easily enters the gaps of the crystal lattice, such that it is effective for causing the synergistic effect to occur.

When a content of C in the metal powder for powder metallurgy is set to c [mass %], it is preferable that c/b is substantially 0.001 to 3, and more preferably, substantially 0.05 to 2, and even more preferably, substantially 0.1 to 1. According to such a metal powder for powder metallurgy, a relative amount of C with respect to Zr and Si is optimized, and thereby it is possible to more reliably obtain the above-described synergistic effect.

In addition, when c/b is less than the lower limit, the relative amount of C with respect to Zr and Si is significantly diminished, such that there is a concern that the synergistic effect may not be obtained. On the other hand, when c/b exceeds the upper limit, the relative amount of C is too large, and there is a concern that the synergistic effect also may not be obtained.

In addition, it is preferable that c is 0.001 to 2.5 mass %, more preferably, 0.01 to 1.5 mass %, and even more preferably, 0.1 to 0.7 mass %.

In addition, when c is less than the lower limit, the amount of C in the metal powder for powder metallurgy becomes absolutely small, and thereby there is a concern that the above-described operation by C may not be exhibited. On the other hand, when c exceeds the upper limit, the amount of C becomes absolutely large, such that there is a concern that the property of the metallic material in the metal powder for powder metallurgy is decreased, and various properties of the sintered compact are deteriorated.

In addition, a mean particle size of the metal powder for powder metallurgy is not particularly limited, but substantially 1 to 30 μm is preferable, and substantially 1 to 20 μm is more preferable. The metal powder for powder metallurgy having such a particle size can be used to eventually produce a sufficiently dense sintered compact while avoiding the decrease in the compaction property at the time of molding.

In addition, when the mean particle size is less than the lower limit, the metal powder for powder metallurgy is apt to aggregate, and thereby there is a concern that the compaction property at the time of molding may be significantly decreased. On the other hand, when the mean particle size exceeds the upper limit, the interparticle gap of the powder becomes too large, such that there is a concern that the densification of the sintered compact eventually obtained may be insufficient.

In addition, it is preferable that a tap density of the metal powder for powder metallurgy according to the invention is 3.5 g/cm³ or more, and more preferably, 4 g/cm³ or more. According to the metal powder for powder metallurgy having such a large tap density, when the green part is obtained, an interparticle filling property is particularly increased. Therefore, eventually, it is possible to obtain a particularly dense sintered compact.

In addition, a specific surface area of the metal powder for powder metallurgy according to the invention is not particularly limited, but 0.1 m²/g or more is preferable, and 0.2 m²/g or more is more preferable. According to a metal powder for powder metallurgy having such a wide specific surface area, a surface activity (a surface energy) becomes high, such that it is possible to easily sinter the metal powder by applying a relatively small energy. Therefore, when the green part is sintered, it is possible to sinter the green part at a relatively low temperature and in a short time.

Such a metal powder for powder metallurgy may be produced by any method, but it is possible to use a metal powder for powder metallurgy produced by, for example, an atomizing method (a water atomizing method, a gas atomizing method, a high-speed water stream atomizing method or the like), a reduction method, a carbonyl method, a crushing method or the like.

Among these, as the metal powder for powder metallurgy, it is preferable to use a metal powder produced by the atomizing method. According to the atomizing method, it is possible to efficiently produce the metal powder with the minute mean particle size as described above. In addition, it is possible to obtain a metal powder that has a low particle size variation and that has a uniform particle size.

In addition, the metal powder for powder metallurgy produced by the atomizing method has a shape that is relatively close to a perfect sphere, such that dispersibility and flowability with respect to a binder become excellent. Therefore, when a composition including such a metal powder is filled into a mold, the filling property thereof can be increased, and eventually, it is possible to obtain a denser sintered compact.

Furthermore, there is an advantage in that variation in composition is small between each of the metal powders.

In addition, in regard to the metal powder for powder metallurgy according to the invention, it is preferable that the metallic material and additive are alloyed or form an intermetallic compound. In such a metal powder, the metallic material and the additive are uniformly distributed in each particle. As a result thereof, the operation of the additive is uniformly exhibited over the entirety of the metal powder, and eventually, it is possible to prevent the sintering variation from occurring.

In addition, such a powder may be produced by, for example, an atomizing method. In the atomizing method, the above-described metallic material and additive are dissolved to become a molten metal, and the molten metal is made to collide with a flowing liquid (liquid or gas) sprayed with a high speed, and the molten metal is pulverized and is cooled, and thereby a metal powder is produced. Therefore, the metallic material and additive are easily alloyed or easily form an intermetallic compound, and thereby uniform particles are obtained.

### Method of Producing Sintered Compact

Next, a sintered body (sintered compact according to the invention) obtained by sintering such a metal powder for powder metallurgy according to the invention will be described.

As a method of producing the sintered compact, there are (A) a composition preparation process of preparing a composition for producing a sintered compact, (B) a molding process of producing a green part, (C) a debinding process of performing a debinding treatment, and (D) a sintering process of performing heating. Hereinafter, each process will be sequentially described.

### A. Composition Preparation Process

First, a metal powder for powder metallurgy according to the invention and a binder are prepared, and these are kneaded by using a kneader and thereby a kneaded material (composition) is obtained.

In the kneaded material (compound), the metal powder for powder metallurgy is uniformly distributed.

As the binder, for example, polyolefins such as polyethylene, polypropylene, and ethylene-vinyl acetate copolymer, acryl-based resins such as polymethyl methacrylate and polybutyl methacrylate, styrene-based resins such as polystyrene, polyester such as polyvinyl chloride, polyvinylidene chloride, polyamide, polyethylene terephthalate, and polybutylene terephthalate, various resins such as polyether, polyvinyl alcohol, polyvinyl pyrrolidone, and copolymers thereof, various organic binders such as various waxes, paraffin, higher fatty acids (for example: stearic acid), higher alcohols, higher fatty acid esters, and higher fatty acid amides may be exemplified, and one kind or two kinds or more of these may be combined to be used.

Among these, as the binder, a binder including polyolefin as a main component thereof is preferable. The polyolefin has a relatively high decomposition property with respect to a reducing gas. Therefore, in a case where a polyolefin is used as a main component of the binder, it is possible to reliably degrease the green part in a relatively short time.

In addition, it is preferable that a content of the binder is substantially 2 to 20 mass % with respect to the entirety of the kneaded material, and more preferably, substantially 5 to 10 mass %. When the content of the binder is within the above-described range, it is possible to mold a green part with a good molding property, to increase a density of the green part, and to make a green part excellent in a stability of a shape of thereof or the like. In addition, according to this, a difference in a size between the green part and the brown part, that is, a degree of shrinkage is optimized, and it is possible to prevent a dimensional accuracy of the sintered compact eventually obtained from being decreased.

In addition, a plasticizer may be added to the kneaded material as necessary. As the plasticizer, for example, phthalate ester (for example: DOP, DEP, DBP), adipate ester, trimellitic acid ester, sebacic acid ester, or the like may be exemplified, and one kind or two kinds or more of these may be combined to be used.

In addition, other than the metal powder for powder metallurgy, binder, and plasticizer, for example, various additives such as an antioxidant, a degreasing promoting agent, and a surfactant may be added to the kneaded material, as necessary.

In addition, a kneading condition is different depending on corresponding conditions such as a metallic composition and a particle size of the metal powder for powder metallurgy used, a composition of the binder, and a combination amount thereof, but as an example, a kneading temperature of substantially 50 to 200° C., and a kneading time of substantially 15 to 210 minutes may be set.

In addition, the kneaded material may be made into a pellet (small mass) as necessary. A particle size of the pellet is set to, for example, substantially 1 to 15 mm.

In addition, a granulated particle may be produced instead of the kneaded material.

### B. Molding Process

Next, the kneaded material is molded to produce a green part having the same shape as that of the intended sintered compact.

A method of producing a green part (molding method), is not particularly limited, but for example, various molding methods such as a powder compacting molding (compacting molding) method, a metal injection molding (MIM) method, and an extrusion molding method may be used.

Among these, a molding condition in the powder compacting molding method is different depending on a composition and a particle size of the metal powder for powder metallurgy used, a composition of the binder, and a combination amount thereof, but a clamping pressure is preferably substantially 200 to 1000 MPa (2 to 10 t/cm²).

In addition, the molding condition in the case of the metal powder injection molding method is different depending on corresponding conditions, but it is preferable that a material temperature is substantially 80 to 210° C., and an injection pressure is substantially 50 to 500 MPa (0.5 to 5 t/cm²).

In addition, the molding condition in the case of the extrusion molding method is different depending on corresponding conditions, but it is preferable that a material temperature is substantially 80 to 210° C., and an injection pressure is substantially 50 to 500 MPa (0.5 to 5 t/cm²).

In the green part obtained in such a manner, the binder is distributed uniformly at a gap of a plurality of particles of the metal powder.

In addition, a shape size of the produced green part is determined in consideration of an amount of shrinkage of the green part in a subsequent debinding process and a subsequent sintering process.

### C. Degreasing Process

Next, the obtained green part is subjected to a degreasing treatment (binder removing treatment), and thereby a brown part is obtained.

Specifically, the green part is heated, the binder is decomposed, the binder is removed from the green part, and thereby the degreasing treatment is completed.

As the degreasing treatment, for example, a method of heating the green part, a method of exposing the green part to a gas decomposing the binder, or the like may be exemplified.

In a case where the method of heating the green part is used, the conditions of heating the green part are slightly different depending on a composition and a combination amount of the binder, but it is preferable that a temperature is substantially 100 to 750° C. and a time is substantially 0.1 to 20 hours, and more preferably, substantially 150 to 600° C. and substantially 0.5 to 15 hours. Therefore, it is possible to necessarily and sufficiently degrease the green part without sintering it. As a result thereof, it is possible to reliably prevent a large amount of binder component from remaining inside the brown part.

In addition, an atmosphere when heating the green part is not particularly limited, but a reducing gas atmosphere such as hydrogen, an inert gas atmosphere such as nitrogen and argon, an oxidizing gas atmosphere such as the atmosphere, a depressurized atmosphere where these atmospheres are depressurized, or the like may be exemplified.

On the other hand, as the gas that decomposes the binder, for example, ozone gas or the like may be exemplified.

In addition, such a degreasing process may be performed by a plurality of separate processes (steps), wherein the degreasing condition is different, and thereby it is possible to more quickly decompose and remove the binder in green part, such that the binder does not remain in the green part.

In addition, as necessary, the brown part may be subjected to a mechanical processing such as machining, grinding, and cutting. The brown part has a relatively low hardness and abundant plasticity, such that it is possible to easily perform the mechanical processing while the shape of the brown part is not destroyed. According to such a mechanical processing, it is easy to eventually obtain a sintered compact having a high dimensional accuracy.

### D. Heating Process

The brown part obtained in the process (C) is heated in a heating furnace to obtain a sintered compact.

Through the sintering, in the metal powder for powder metallurgy, particles are diffused at an interface thereof and reach a sintered state.

At this time, by the above-described mechanism, the brown part is quickly sintered. As a result thereof, a highly dense sintered compact, which is wholly dense, is obtained.

The heating temperature is different depending on a composition, a particle size, or the like of the metal powder for powder metallurgy used for producing the green part and brown part, but in the invention, the heating temperature is set to a temperature of 70% to 95% of a melting point of the metallic material. Such a temperature is a low temperature compared to the sintering temperature in the related art. Therefore, in the metal powder for powder metallurgy in the related art, even when the heating is performed at such a low temperature range, the sintering does not sufficiently progress, and thereby it is difficult to increase the density of the sintered compact.

On the contrary, when the metal powder according to the invention is used, the sintering property is significantly improved due to an operation of an additive, such that even when the heating is performed at such a low temperature, the sintering is sufficiently promoted, and thereby it is possible to obtain a sintered compact with a high density.

In addition, it is preferable that the heating temperature is substantially 75% to 90% of the melting point of the main component.

For example, when SUS 316L, which is an austenitic stainless steel, is used as the metallic material, the heating temperature of the brown part of the metal powder for powder metallurgy is substantially 980 to 1330° C., since the melting point of SUS 316L is substantially 1400° C. In addition, a temperature of substantially 1050 to 1260° C. is preferable.

In addition, a heating time is set to 0.2 to 7 hours, but it is preferably set to 1 to 4 hours.

When the heating condition is set within this range, it is possible to wholly and sufficiently sinter the brown part while preventing the sintering from progressing too far and thereby prevent the crystalline structure from being enlarged. As a result thereof, it is possible to obtain a sintered compact that has a high density and that is particularly excellent in terms of mechanical properties.

In addition, since the heating temperature is a relatively low temperature, it is easy to constantly control the heating temperature by a heating furnace, and therefore the temperature of the brown part is easily made to be constant. As a result thereof, it is possible to produce a more uniform sintered compact.

Furthermore, the above heating temperature is a heating temperature that can be realized sufficiently by a general heating furnace, such that an inexpensive heating furnace can be used and a running cost can be suppressed. In other words, when it exceeds the heating temperature, there is concern that it is necessary to use an expensive heating furnace provided with a special heat-resistant material, and the running cost is also increased.

In addition, an atmosphere at the time of heating is not particularly limited, but when considering the prevention of oxidation of the metal powder, a reducing gas atmosphere such as hydrogen, an inert gas atmosphere such as argon, a depressurized atmosphere where these atmospheres are depressurized, or the like is preferably used.

The green part obtained in such a manner has a high relative density regardless of being heated at a relatively low temperature.

That is, the sintered compact, which is obtained by molding a composition of the metal powder for powder metallurgy according to the invention and a binder, and degreasing and sintering the resultant green part, has a relative density higher than that of a sintered compact that is obtained by sintering a metal powder not including the above-described additive. Therefore, according to the invention, with respect to a metallic material having a composition with which it is difficult to obtain a sintered compact with a high sintered density in the related art, it is possible to select a material with a priority being given to electromagnetic properties, chemical properties, or the like of the metallic material without considering the sintering property. Therefore, according to the invention, it is possible to broaden a width of the composition of the metallic material, and it is possible to easily realize a sintered compact that has abundant electromagnetic properties and chemical properties.

In addition, specifically, the relative density of the sintered compact is slightly different depending on a composition of the metal powder for powder metallurgy, but it is possible to expect an improvement in the relative density by 2% or more by adding the additive.

As a result thereof, the relative density of the sintered compact obtained is expected to be 96% or more (preferably, 97% or more). Since the sintered compact having a relative density within such a range has mechanical properties comparable to a cast material by using a powder metallurgy technology, even when the sintered compact has a shape very close to an intended shape, the sintered compact can be adapted to various mechanical parts or the like without being post-processed.

In addition, the sintered compact, which is obtained by molding a composition of the metal powder for powder metallurgy according to the invention and a binder, and degreasing and sintering the resultant green part, has a tensile strength and 0.2% yield strength thereof larger than those of a sintered compact obtained by sintering the metal powder without adding the additive. This is considered to be because the sintering property of the metal powder is increased by the addition of the additive and thereby the mechanical properties are improved.

Specifically, although it is slightly different depending on a composition of the metal powder for powder metallurgy, nevertheless it is expected that the tensile strength will be improved by 5% or more, and the 0.2% yield strength will be improved by 5% or more. As a result thereof, for example, in the case of a sintered compact of SUS 316L, it is possible to obtain a sintered compact that has a tensile strength of 500 MPa or more and a 0.2% yield strength of 160 MPa or more, and is excellent in terms of mechanical properties.

As described above, if the metal powder for powder metallurgy according to the invention is used, even in a case where the metal powder has a composition with an inferior sintering property or in a case where heating is performed in a low temperature range, it is possible to realize densification in the sintering. As a result thereof, it is possible to obtain a metal powder for powder metallurgy that can be used to easily produce a sintered compact that has a high density and is excellent in terms of mechanical properties.

Hereinbefore, description is given with respect to the metal powder for powder metallurgy according to the invention and a sintered compact based on a preferable embodiment, but the invention is not limited thereto.

### EXAMPLES

Next, examples of the invention will be described.

### 1. Production of Sintered Compact of SUS 316L Series Stainless Steel.

### Example 1A

(1) First, SUS 316L series powder (manufactured by Epson Atmix Corporation) with a composition shown in Table 1, which was produced by a water atomizing method, was prepared. In addition, a mean particle size of the SUS 316L series powder was 9.87 μm, a tap density was 4.38 g/cm³, and a specific surface area was 0.24 m²/g. In addition, a melting point of the SUS 316L material was substantially 1400° C.

In addition, compositions of the powder shown in Table 1 were identified by an inductively-coupled high frequency plasma emission spectrometry method (ICP method). In addition, in the ICP analysis, an ICP apparatus (CIROS 120 type, manufactured by Rigaku corporation) was used.

TABLE 1
(SUS 316L)

| | | | | | | | | | Evaluation result |
|---|---|---|---|---|---|---|---|---|---|
| Composition of metal powder of powder metallurgy | | | | | | | | | of sintered |
| C | Si | | | | Zr | | | | compact |
| (c) | (b) | Ni | Cr | Mo | (a) | Fe | a/b | c/b | Relative density |
| mass % | mass % | mass % | mass % | mass % | mass % | — | — | — | % |

| | | | | | | | | |
|---|---|---|---|---|---|---|---|---|
| Example 1A | 0.35 | 12.48 | 16.31 | 2.09 | 0.04 | Remainder | 0.114 | 97.7 |
| Example 2A | 0.57 | 12.64 | 16.44 | 2.07 | 0.06 | Remainder | 0.105 | 98.0 |
| Example 3A | 0.78 | 12.45 | 16.41 | 2.11 | 0.06 | Remainder | 0.077 | 98.1 |
| Example 4A | 0.81 | 12.51 | 16.48 | 2.15 | 0.05 | Remainder | 0.062 | 97.8 |
| Example 5A | 1.20 | 12.36 | 16.37 | 2.14 | 0.06 | Remainder | 0.050 | 96.3 |
| Example 6A | 1.25 | 12.49 | 16.41 | 2.16 | 0.25 | Remainder | 0.200 | 95.9 |
| Example 7A | 1.23 | 12.52 | 16.43 | 2.15 | 0.35 | Remainder | 0.285 | 95.9 |
| Comparative | 0.83 | 12.45 | 16.51 | 2.13 | 0.00 | Remainder | 0.000 | 95.7 |
| Example 1A | | | | | | | | |
| Comparative | 0.34 | 12.43 | 16.47 | 2.11 | 0.00 | Remainder | 0.000 | 95.6 |
| Example 2A | | | | | | | | |
| Comparative | 1.03 | 12.55 | 16.35 | 2.07 | 0.00 | Remainder | 0.000 | 95.8 |
| Example 3A | | | | | | | | |
| Comparative | 1.56 | 12.54 | 16.39 | 2.13 | 0.11 | Remainder | 0.071 | 94.1 |
| Example 4A | | | | | | | | |

(2) Next, an organic binder was dissolved in water (solvent) to produce a binder solution.

In addition, an amount of organic binder in the binder solution was set to 10 g per 1 kg of metal powder. In addition, an amount of water in the binder solution was set to 50 g per 1 g of organic binder.

(3) Next, the metal powder was poured into a processing vessel of a granulation apparatus. Then, the metal powder was shaken and granulated while spraying the binder solution from a spray nozzle of the granulation apparatus toward the metal powder in the processing vessel, and thereby a granulated powder was obtained.

(4) Next, the granulated powder obtained was molded under molding condition described below, and a green part was obtained.

### Molding Conditions

Molding method: Powder compacting molding
Clamping pressure: 600 MPa (6 t/cm²)

(5) Next, the molded compact was degreased under the following degreasing conditions and thereby a degreased body was obtained.

### Degreasing Conditions

Heating temperature: 470° C.
Heating time: 1 hour
Heating atmosphere: Argon atmosphere

(6) Next, the obtained degreased compact was heated under the following heating conditions, and thereby a sintered compact was obtained.

### Heating Conditions

Heating temperature: 1100° C. (79% of a melting point)
Heating time: 3 hours
Heating atmosphere: Argon atmosphere

### Examples 2A to 7A

Sintered bodies were obtained similarly to Example 1A, except that a composition of the metal powder for powder metallurgy was changed as shown in Table 1.

### Comparative Examples 1A to 4A

Sintered compacts were obtained similarly to Example 1A, except that a composition of the metal powder for powder metallurgy was changed as shown in Table 1.

2. Production of a Sintered Compact of an SCM415 Series

Chromium-Molybdenum Steel

### Example 1B

First, an SCM 415 series powder (produced by Epson Atmix Corporation) that had a composition shown in Table 2 and was produced by a water atomizing method was prepared. In addition, a mean particle size of the SCM415 series powder was 9.74 μm.

Next, similarly to Example 1A, a sintered compact was obtained. In addition, a heating temperature at the time of the heating was set to 87% of a melting point of the SCM 415 material.

TABLE 2
(SCM415)

| | | | | | | | | | | Evaluation result |
|---|---|---|---|---|---|---|---|---|---|---|
| | Composition of metal powder of powder metallurgy | | | | | | | | | of sintered |
| | C | Si | | | | Zr | | | | compact |
| | (c) | (b) | Ni | Cr | Mo | (a) | Fe | a/b | c/b | Relative density |
| | mass % | mass % | mass % | mass % | mass % | mass % | — | — | — | % |
| Example 1B | 0.15 | 0.35 | | 1.01 | 0.24 | 0.06 | Remainder | 0.171 | 0.429 | 93.7 |
| Example 2B | 0.16 | 0.79 | | 0.99 | 0.22 | 0.05 | Remainder | 0.063 | 0.203 | 97.0 |
| Example 3B | 0.17 | 0.41 | | 1.03 | 0.21 | 0.03 | Remainder | 0.073 | 0.415 | 96.6 |
| Example 4B | 0.15 | 0.65 | | 1.05 | 0.24 | 0.04 | Remainder | 0.062 | 0.231 | 96.7 |
| Comparative | 0.15 | 0.25 | | 1.00 | 0.21 | 0.00 | Remainder | 0.000 | 0.600 | 93.1 |
| Example 1B | | | | | | | | | | |
| Comparative | 0.14 | 0.15 | | 1.02 | 0.25 | 0.00 | Remainder | 0.000 | 0.933 | 93.1 |
| Example 2B | | | | | | | | | | |
| Comparative | 0.14 | 0.83 | | 1.05 | 0.23 | 0.00 | Remainder | 0.000 | 0.169 | 93.5 |
| Example 3B | | | | | | | | | | |
| Comparative | 0.16 | 0.29 | | 0.98 | 0.22 | 0.05 | Remainder | 0.172 | 0.552 | 93.2 |
| Example 4B | | | | | | | | | | |

### Examples 2B to 4B

Sintered compacts were obtained similarly to Example 1B, except that a composition of the metal powder for powder metallurgy was changed as shown in Table 2.

### Comparative Examples 1B to 4B

Sintered compacts were obtained similarly to Example 1B, except that a composition of the metal powder for powder metallurgy was changed as shown in Table 2.

### 3. Production of Sintered Compact of SNCM 439 Series Nickel-Chromium-Molybdenum Steel

### Example 1C

First, an SNCM439 series powder (produced by Epson Atmix Corporation) that had a composition shown in Table 3 and was produced by a water atomizing method was prepared. In addition, a mean particle size of the SNCM439 series powder was 10.12 μm.

Next, similarly to Example 1A, a sintered compact was obtained. In addition, a heating temperature at the time of the heating was set to 85% of the melting point of the SNCM439 material.

TABLE 3
(SNCM439)

| | | | | | | | | | | Evaluation result |
|---|---|---|---|---|---|---|---|---|---|---|
| | Composition of metal powder of powder metallurgy | | | | | | | | | of sintered |
| | C | Si | | | | Zr | | | | compact |
| | (c) | (b) | Ni | Cr | Mo | (a) | Fe | a/b | c/b | Relative density |
| | mass % | mass % | mass % | mass % | mass % | mass % | — | — | — | % |
| Example 1C | 0.42 | 0.85 | 1.85 | 0.85 | 0.22 | 0.05 | Remainder | 0.059 | 0.494 | 97.5 |
| Example 2C | 0.41 | 0.73 | 1.83 | 0.88 | 0.25 | 0.07 | Remainder | 0.096 | 0.562 | 97.9 |
| Example 3C | 0.39 | 0.66 | 1.81 | 0.87 | 0.26 | 0.08 | Remainder | 0.121 | 0.591 | 97.7 |
| Example 4C | 0.39 | 0.59 | 1.68 | 0.91 | 0.21 | 0.04 | Remainder | 0.068 | 0.661 | 97.3 |
| Example 5C | 0.17 | 0.39 | 1.80 | 0.93 | 0.25 | 0.03 | Remainder | 0.077 | 0.436 | 97.0 |
| Example 6C | 0.56 | 0.91 | 1.84 | 0.89 | 0.23 | 0.05 | Remainder | 0.055 | 0.615 | 96.6 |
| Example 7C | 0.68 | 1.02 | 1.79 | 0.88 | 0.24 | 0.06 | Remainder | 0.059 | 0.667 | 96.4 |
| Example 8C | 0.75 | 1.23 | 1.85 | 0.91 | 0.26 | 0.04 | Remainder | 0.033 | 0.610 | 96.1 |
| Comparative | 0.41 | 0.23 | 1.82 | 0.88 | 0.19 | 0.00 | Remainder | 0.000 | 1.783 | 93.6 |
| Example 1C | | | | | | | | | | |
| Comparative | 0.39 | 0.16 | 1.64 | 0.95 | 0.26 | 0.00 | Remainder | 0.000 | 2.438 | 93.5 |
| Example 2C | | | | | | | | | | |
| Comparative | 0.38 | 0.26 | 1.77 | 0.84 | 0.21 | 0.05 | Remainder | 0.192 | 1.462 | 93.6 |
| Example 3C | | | | | | | | | | |
| Comparative | 0.40 | 0.80 | 1.79 | 0.87 | 0.23 | 0.00 | Remainder | 0.000 | 0.500 | 93.9 |
| Example 4C | | | | | | | | | | |

### Examples 2C to 8C

Sintered compacts were obtained similarly to Example 1C, except that a composition of the metal powder for powder metallurgy was changed as shown in Table 3.

### Comparative Examples 1C to 4C

Sintered compacts were obtained similarly to Example 1C, except that a composition of the metal powder for powder metallurgy was changed as shown in Table 3.

### 4. Production of Sintered Body of 2% Ni—Fe Series Low-Alloy Steel

### Example 1D

First, 2% Ni—Fe series powder (produced by Epson Atmix Corporation) that had a composition shown in Table 4 and was produced by a water atomizing method was prepared. In addition, a mean particle size of the 2% Ni—Fe series powder was 9.74 μm.

Next, similarly to Example 1A, a sintered compact was obtained. In addition, a heating temperature at the time of the heating was set to 81% of the melting point of the 2% Ni—Fe material.

TABLE 4
(2% Ni—Fe)

| | | | | | | | | | Evaluation | |
|---|---|---|---|---|---|---|---|---|---|---|
| | | | | | | | | | result of | |
| Composition of metal powder of powder metallurgy | | | | | | | | | sintered compact | |
| C | Si | | | | Zr | | | | Relative | Tensile |
| (c) | (b) | Ni | Cr | Mo | (a) | Fe | a/b | c/b | density | strength |
| mass % | mass % | mass % | mass % | mass % | mass % | — | — | — | % | MPa |

| | | | | | | | | | |
|---|---|---|---|---|---|---|---|---|---|
| Example 1D | 0.01 | 0.39 | 2.02 | 0.03 | Remainder | 0.077 | 0.031 | 96.5 | — |
| Example 2D | 0.18 | 0.36 | 2.04 | 0.04 | Remainder | 0.111 | 0.500 | 96.8 | — |
| Example 3D | 0.48 | 0.84 | 1.97 | 0.10 | Remainder | 0.119 | 0.571 | 97.7 | 848 |
| Example 4D | 0.47 | 0.65 | 2.01 | 0.07 | Remainder | 0.108 | 0.723 | 97.8 | — |
| Comparative | 0.00 | 0.20 | 2.04 | 0.02 | Remainder | 0.100 | 0.000 | 95.2 | — |
| Example 1D | | | | | | | | | |
| Comparative | 0.00 | 0.19 | 1.98 | 0.02 | Remainder | 0.105 | 0.005 | 96.0 | 546 |
| Example 2D | | | | | | | | | |
| Comparative | 0.00 | 0.22 | 1.99 | 0.00 | Remainder | 0.000 | 0.014 | 96.0 | 338 |
| Example 3D | | | | | | | | | |
| Comparative | 0.00 | 0.21 | 1.97 | 0.01 | Remainder | 0.048 | 0.014 | 96.0 | 345 |
| Example 4D | | | | | | | | | |
| Comparative | 0.45 | 0.25 | 2.00 | 0.00 | Remainder | 0.000 | 1.800 | 95.9 | 549 |
| Example 5D | | | | | | | | | |
| Comparative | 0.47 | 0.81 | 2.05 | 0.00 | Remainder | 0.000 | 0.580 | 96.4 | 698 |
| Example 6D | | | | | | | | | |
| Comparative | 0.01 | 0.00 | 2.05 | 0.00 | Remainder | — | — | 95.3 | 614 |
| Example 7D | | | | | | | | | |

### Examples 2D to 4D

Sintered compacts were obtained similarly to Example 1D, except that a composition of the metal powder for powder metallurgy was changed as shown in Table 4.

### Comparative Examples 1D to 7D

Sintered compacts were obtained similarly to Example 1D, except that a composition of the metal powder for powder metallurgy was changed as shown in Table 4.

### 5. Production of Sintered Body of 8% Ni—Fe Series Low-Alloy Steel

### Example 1E

First, 8% Ni—Fe series powder (produced by Epson Atmix Corporation) that had a composition shown in Table 5 and was produced by a water atomizing method was prepared. In addition, a mean particle size of the 8% Ni—Fe series powder was 9.84 μm.

Next, similarly to Example 1A, a sintered compact was obtained. In addition, a heating temperature at the time of the heating was set to 84% of the melting point of the 8% Ni—Fe material.

TABLE 5
(8% Ni—Fe)

| | | | | | | | | | Evaluation result |
|---|---|---|---|---|---|---|---|---|---|
| Composition of metal powder of powder metallurgy | | | | | | | | | of sintered |
| C | Si | | | | Zr | | | | compact |
| (c) | (b) | Ni | Cr | Mo | (a) | Fe | a/b | c/b | Relative density |
| mass % | mass % | mass % | mass % | mass % | mass % | — | — | — | % |

| | | | | | | | | |
|---|---|---|---|---|---|---|---|---|
| Example 1E | 0.51 | 0.35 | 8.00 | 0.05 | Remainder | 0.143 | 1.457 | 92.7 |
| Example 2E | 0.50 | 0.85 | 8.07 | 0.10 | Remainder | 0.118 | 0.588 | 97.1 |
| Example 3E | 0.49 | 0.79 | 7.97 | 0.05 | Remainder | 0.063 | 0.620 | 96.9 |
| Example 4E | 0.51 | 0.54 | 8.01 | 0.04 | Remainder | 0.074 | 0.944 | 96.9 |
| Example 5E | 0.78 | 0.36 | 8.02 | 0.08 | Remainder | 0.222 | 2.167 | 95.4 |
| Example 6E | 1.52 | 0.41 | 8.06 | 0.12 | Remainder | 0.293 | 3.707 | 94.3 |
| Comparative | 0.47 | 0.21 | 8.03 | 0.00 | Remainder | 0.000 | 2.238 | 92.4 |
| Example 1E | | | | | | | | |
| Comparative | 0.49 | 0.28 | 7.98 | 0.00 | Remainder | 0.000 | 1.750 | 92.2 |
| Example 2E | | | | | | | | |
| Comparative | 1.61 | 0.35 | 7.87 | 0.11 | Remainder | 0.314 | 4.600 | 90.9 |
| Example 3E | | | | | | | | |
| Comparative | 2.45 | 1.04 | 8.01 | 0.03 | Remainder | 0.029 | 2.356 | 91.8 |
| Example 4E | | | | | | | | |
| Comparative | 2.79 | 1.45 | 7.99 | 0.03 | Remainder | 0.021 | 1.924 | 91.5 |
| Example 5E | | | | | | | | |

### Examples 2E to 6E

Sintered compacts were obtained similarly to Example 1E, except that a composition of the metal powder for powder metallurgy was changed as shown in Table 5.

### Comparative Examples 1E to 5E

Sintered compacts were obtained similarly to Example 1E, except that a composition of the metal powder for powder metallurgy was changed as shown in Table 5.

### 6. Production of Sintered Body of Co—Cr—Mo Series Alloy Example 1F

First, Co—Cr—Mo series powder (produced by Epson Atmix Corporation) that had a composition shown in Table 6 and was produced by a water atomizing method was prepared. In addition, a mean particle size of the Co—Cr—Mo series powder was 9.93 μm.

Next, similarly to Example 1F, a sintered compact was obtained. In addition, a heating temperature at the time of the heating was set to 72% of the melting point of the Co—Cr—Mo material.

TABLE 6
(Co—Cr—Mo)

| | | | | | | | | | Evaluation result |
|---|---|---|---|---|---|---|---|---|---|
| Composition of metal powder of powder metallurgy | | | | | | | | | of sintered |
| C | Si | | | | Zr | | | | compact |
| (c) | (b) | Ni | Cr | Mo | (a) | Fe | a/b | c/b | Relative density |
| mass % | mass % | mass % | mass % | mass % | mass % | — | — | — | % |

| | | | | | | | |
|---|---|---|---|---|---|---|---|
| Example 1F | 0.85 | 28.74 | 5.80 | 0.03 | Remainder | 0.035 | 97.7 |
| Example 2F | 0.38 | 28.54 | 5.69 | 0.03 | Remainder | 0.079 | 97.6 |
| Example 3F | 1.14 | 28.79 | 5.73 | 0.07 | Remainder | 0.061 | 96.3 |
| Comparative | 0.79 | 28.43 | 5.76 | 0.00 | Remainder | 0.000 | 94.9 |
| Example 1F | | | | | | | |
| Comparative | 0.99 | 28.65 | 5.93 | 0.00 | Remainder | 0.000 | 95.0 |
| Example 2F | | | | | | | |
| Comparative | 0.42 | 28.81 | 5.85 | 0.00 | Remainder | 0.000 | 94.8 |
| Example 3F | | | | | | | |

### Examples 2F and 3F

Sintered compacts were obtained similarly to Example 1F, except that a composition of the metal powder for powder metallurgy was changed as shown in Table 6.

### Comparative Examples 1F to 3F

Sintered compacts were obtained similarly to Example 1F, except that a composition of the metal powder for powder metallurgy was changed as shown in Table 6.

### 7. Evaluation on Sintered Body

### 7.1 Measurement of Sintered Density

With respect to the sintered compacts obtained in each of the examples and each of the comparative examples, a sintered density was measured, respectively. In addition, the measurement of the sintered density was performed by a method compliant to Archimedes' law (defined in JIS Z 2501).

In addition, a relative density of the sintered compact obtained in each of the examples and each of the comparative examples was calculated from the measured sintered density and a true density of a metallic material used in each of the examples and the comparative examples.

### 7.2 Measurement of Tensile Strength

With respect to a part of the sintered compacts obtained in each of the examples and the comparative examples, a tensile strength was measured, respectively. In addition, the measurement of the tensile strength was performed according to a method defined in JIS Z 2241.

Measurement Results of 7.1 are shown in Tables 1 to 6. In addition, measurement results of 7.2 are shown in Table 4.

As is obvious from Tables 1 to 6, in each of the examples, a sintered compact having a density higher than that in the comparative examples was obtained. Therefore, it was obvious that the metal powder for powder metallurgy including Zr and Si in a predetermined ratio could have a high sintering property thereof.

Specifically, it was confirmed that when C is further included with a predetermined ratio with respect to Zr and Si, the sintering property of the metal powder for powder metallurgy was further raised.

In addition, it was confirmed that the sintered compact obtained in each of the examples had a high tensile strength and was excellent in terms of mechanical properties compared to the sintered compact obtained in each of the comparative examples.

8. Evaluation of sintered Compact Subjected to a Low Temperature Heating

Next, in regard to the metal powders for powder metallurgy obtained in Example 3D and each of Comparative Examples 2D to 7D, sintered compacts were produced under conditions of a heating temperature of 1100° C. and a heating temperature of 1300° C., respectively. In addition, a heating time was set to 3 hours, respectively, and a heating atmosphere was set as an argon atmosphere.

Then, the sintered density of the sintered compact obtained was measured, respectively. A relative density calculated from the measured sintered density is shown in Table 7.

TABLE 7
(2% Ni—Fe)

| | | | | | | | | | Relative density of | |
|---|---|---|---|---|---|---|---|---|---|---|
| Composition of metal powder of powder metallurgy | | | | | | | | | sintered compact | |
| C | Si | | | | Zr | | | | Heating | Heating |
| (c) | (b) | Ni | Cr | Mo | (a) | Fe | a/b | c/b | temperature | temperature |
| mass % | mass % | mass % | mass % | mass % | mass % | — | — | — | 1100° C. % | 1300° C. % |

| | | | | | | | | | |
|---|---|---|---|---|---|---|---|---|---|
| Example 3D | 0.48 | 0.84 | 1.97 | 0.10 | Remainder | 0.119 | 0.571 | 96.5 | 97.7 |
| Comparative | 0.00 | 0.19 | 1.98 | 0.02 | Remainder | 0.105 | 0.005 | 94.6 | 96.0 |
| Example 2D | | | | | | | | | |
| Comparative | 0.00 | 0.22 | 1.99 | 0.00 | Remainder | 0.000 | 0.014 | 90.7 | 96.0 |
| Example 3D | | | | | | | | | |
| Comparative | 0.00 | 0.21 | 1.97 | 0.01 | Remainder | 0.048 | 0.014 | 91.2 | 96.0 |
| Example 4D | | | | | | | | | |
| Comparative | 0.45 | 0.25 | 2.00 | 0.00 | Remainder | 0.000 | 1.800 | 93.8 | 95.9 |
| Example 5D | | | | | | | | | |
| Comparative | 0.47 | 0.81 | 2.05 | 0.00 | Remainder | 0.000 | 0.580 | 95.0 | 96.4 |
| Example 6D | | | | | | | | | |
| Comparative | 0.01 | 0.00 | 2.05 | 0.00 | Remainder | — | — | 93.9 | 95.3 |
| Example 7D | | | | | | | | | |

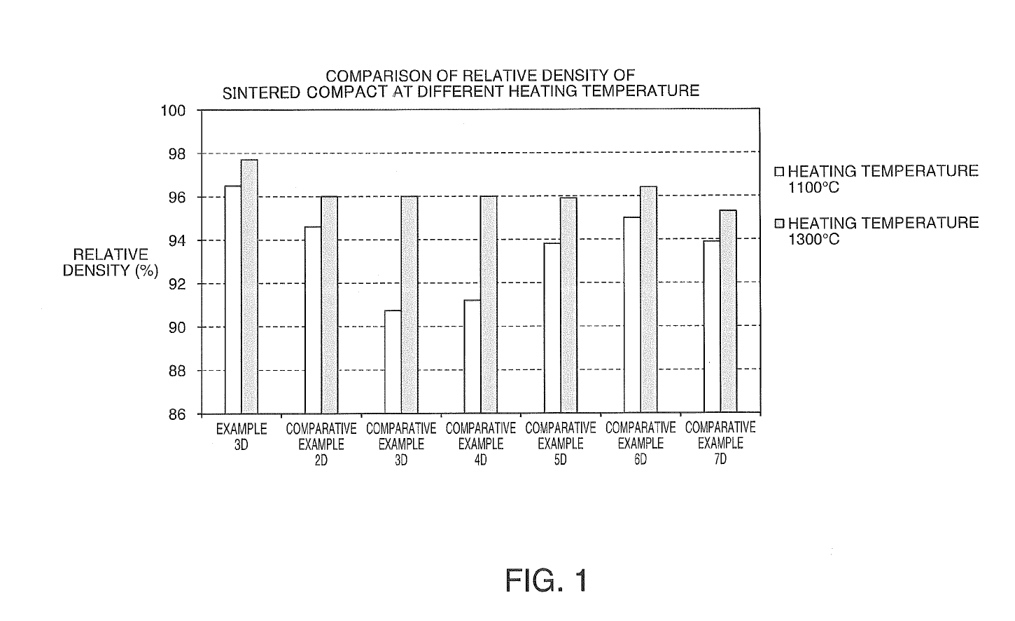

In addition, a relative density of the sintered compacts, which were obtained in Example 3D and each of the Comparative Examples 2D to 7D, for each heating temperature, was shown as a graph in FIG. 1.

As is obvious from FIG. 1, in a case where the metal powder for powder metallurgy obtained in Example 3D was used, even when the heating was performed at a low temperature of 1100° C., it was possible to obtain a sintered compact with a high density of 96.5% or more. If a sufficient density could be obtained even when the heating was performed at such a low temperature, it was possible to produce a sintered compact having a high quality by an inexpensive heating furnace even when a special heat-resistant material was not used. In addition, dimensional variations due to heat were suppressed, and it was possible to increase the dimensional accuracy in the sintered compact. As a result thereof, a post processing was not necessary, a production process was made to be simple, and a reduction in cost was realized.

In addition, even when the heating was performed with respect to the metal powders for powder metallurgy with the same composition at the same temperature, the relative density of the sintered compact after sintering varied depending on a particle size.

In addition, in regard to the metal powder for powder metallurgy of 2% Ni—Fe, the evaluation of the sintered compact was also performed by using a powder with the same composition as that shown in Table 4, with respect to powders having a mean particle size 3 μm, 5 μm, 15 μm, and 25 μm. As a result thereof, even when the particle size was changed, the tendency of the sintering property was not different from the case in Table 4. On the other hand, it was confirmed that as the particle size became smaller, the relative density became higher.

On the other hand, when the metal powder for powder metallurgy obtained in each of the comparative examples was used, it was difficult to obtain a sufficient sintering density at a heating temperature of 1100° C. In addition, even when the heating was performed at 1300° C., it did not exceed the density of the sintered compact obtained by heating the metal powder for powder metallurgy obtained in examples at 1100° C.

The entire disclosure of Japanese Patent Application No. 2010-143441, filed Jun. 24, 2010 is expressly incorporated by reference herein.

What is claimed is:

1. A metal powder for powder metallurgy comprising:
Zr and Si in a manner such that following conditions of (A) and (B) are satisfied,
wherein a remainder thereof includes at least one element selected from the group consisting of Fe, Co and Ni,
(A) the mass ratio of a content of Zr to a content of Si is 0.03 to 0.3, and
(B) the content of Si is 0.35 to 1.5% by mass.

2. The metal powder for powder metallurgy according to claim 1,
wherein the content of Zr is 0.015 to 0.3% by mass.

3. The metal powder for powder metallurgy according to claim 1, further comprising:
C (carbon),
wherein the mass ratio of a content of C to the content of Si is 0.001 to 3.

4. The metal powder for powder metallurgy according to claim 3,
wherein the content of C is 0.001 to 2.5% by mass.

5. The metal powder for powder metallurgy according to claim 3,
wherein the metal element includes Fe,
the content of Zr is 0.03 to 0.1% by mass,
the content of Si is 0.5 to 0.8% by mass, and
the content of C is 0.1 to 0.7% by mass.

6. The metal powder for powder metallurgy according to claim 1,
wherein the metal element is a metal element making up an austenitic stainless steel.

7. The metal powder for powder metallurgy according to claim 1,
wherein the metal element is a metal element corresponding to a composition where an atomic arrangement at a sintering temperature is a face-centered cubic lattice.

8. The metal powder for powder metallurgy according to claim 1,
wherein the metal element, and the Zr and Si form an alloy or an intermetallic compound.

9. The metal powder for powder metallurgy according to claim 1,
wherein a mean particle size is 1 to 30 μm.

10. The metal powder for powder metallurgy according to claim 1,
wherein the metal powder for powder metallurgy is produced by an atomizing method.

11. A sintered compact that is produced by molding the metal powder for powder metallurgy according to claim 1 into a predetermined shape, and sintering the obtained green part.

12. A sintered compact that is produced by molding the metal powder for powder metallurgy according to claim 2 into a predetermined shape, and sintering the obtained green part.

13. A sintered compact that is produced by molding the metal powder for powder metallurgy according to claim 3 into a predetermined shape, and sintering the obtained green part.

14. A sintered compact that is produced by molding the metal powder for powder metallurgy according to claim 4 into a predetermined shape, and sintering the obtained green part.

15. A sintered compact that is produced by molding the metal powder for powder metallurgy according to claim 5 into a predetermined shape, and sintering the obtained green part.

16. The sintered compact according to claim 11,
wherein a relative density is 96% or more.

17. The sintered compact according to claim 12,
wherein a relative density is 96% or more.

18. The sintered compact according to claim 13,
wherein a relative density is 96% or more.

19. The sintered compact according to claim 14,
wherein a relative density is 96% or more.

20. The sintered compact according to claim 15,
wherein a relative density is 96% or more.
